(19) United States
(12) Patent Application Publication
(10) Pub. No.: US 2025/0147516 A1
(43) Pub. Date: May 8, 2025

(54) FLIGHT CONTROL METHOD, APPARATUS AND AIRCRAFT

(71) Applicant: SZ DJI TECHNOLOGY CO., LTD., Shenzhen (CN)

(72) Inventors: Xiang LI, Shenzhen (CN); Qi SUI, Shenzhen (CN); Li JIANG, Shenzhen (CN); Zhimeng SHANG, Shenzhen (CN)

(73) Assignee: SZ DJI TECHNOLOGY CO., LTD., Shenzhen (CN)

(21) Appl. No.: 19/017,377

(22) Filed: Jan. 10, 2025

Related U.S. Application Data
(63) Continuation of application No. PCT/CN2022/114501, filed on Aug. 24, 2022.

(51) Int. Cl. G05D 1/48; G05D 1/241; G05D 109/25

(52) U.S. Cl. CPC G05D 1/48; G05D 1/241; G05D 2109/254

(57) ABSTRACT

A flight control method and device, and an aircraft are provided. The method includes: in a flight state, in response to a collision between an aircraft and an object, generating a trigger signal for characterizing an abnormality; and in response to the trigger signal, reducing rotation speeds of all motors in a power system of the aircraft to reduce a flight altitude of the aircraft, and adjusting an attitude of the aircraft to a normal attitude. It can reduce the occurrence of abnormal situations in which an aircraft flips over after colliding with an obstacle and finally firmly attached to the obstacle.

### RELATED APPLICATIONS

This application is a continuation application of PCT application No. PCT/CN2022/114501, filed on Aug. 24, 2022, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present application relates to the field of aircraft technology, and in particular to a flight control method, an apparatus and an aircraft.

### BACKGROUND

With the rapid development of science and technology, the aircraft, such as unmanned aerial vehicle (UAV) has seen widespread development and application due to their good stability and strong anti-interference capabilities.

Currently, although the aircraft flight control technology is becoming increasingly mature, abnormal situations can still occur during aircraft flights. One possible abnormal situation is that after an aircraft collides with an obstacle (such as a wall), it may flip over and eventually become firmly attached to the obstacle. Another possible abnormal situation is that due to wind disturbances or control errors, there may be a drift in the pitch attitude difference between an aircraft's body and its camera system, making it unable to maintain a constant attitude.

Therefore, reducing the occurrence of abnormal situations during aircraft flights has become an urgent issue that needs to be addressed.

### SUMMARY

Embodiments of the present application provide a flight control method and device, an aircraft and a storage medium to address the issue of reducing the occurrence of abnormal situations during aircraft flights in the existing technology.

In a first aspect, embodiments of the present application provide a flight control method, including: in a flight state, in response to a collision between an aircraft and an object, generating a trigger signal for characterizing an abnormality; and in response to the trigger signal, reducing rotation speeds of all motors in a power system of the aircraft to reduce a flight altitude of the aircraft, and adjusting an attitude of the aircraft to a normal attitude.

In a second aspect, embodiments of the present application provide a flight control device, including: at least one storage medium storing at least one set of instructions; and at least one processor in communication with the at least one storage medium, where during operation, the at least one processor executes the at least one set of instructions to cause the device to at least: in a flight state, in response to a collision between an aircraft and an object, generate a trigger signal for characterizing an abnormality, and in response to the trigger signal, reduce rotation speeds of all motors in a power system of the aircraft to reduce a flight altitude of the aircraft, and adjust an attitude of the aircraft to a normal attitude.

In a third aspect, embodiments of the present application provide an aircraft, including: at least one storage medium storing at least one set of instructions; and at least one processor in communication with the at least one storage medium, where during operation, the at least one processor executes the at least one set of instructions to cause the device to at least: in a flight state, in response to a collision between an aircraft and an object, generate a trigger signal for characterizing an abnormality, and in response to the trigger signal, reduce rotation speeds of all motors in a power system of the aircraft to reduce a flight altitude of the aircraft, and adjust an attitude of the aircraft to a normal attitude.

Embodiments of the present application provide a flight control method and device, and an aircraft. By responding to a collision between the aircraft and another object, a trigger signal for characterizing an abnormality is generated. In response to the trigger signal, the speeds of all motors in the power system of the aircraft are reduced to lower the flight altitude of the aircraft, and the attitude of the aircraft is then adjusted to a normal attitude. This can reduce the occurrence of abnormal situations in which the aircraft may flip over after hitting an obstacle and finally attached to the obstacle.

### BRIEF DESCRIPTION OF THE DRAWINGS

To provide a clearer explanation of the technical solutions in the embodiments of this application or the existing technology, a brief introduction to the drawings used in the descriptions of the embodiments of the present application or the existing technology is provided below. It is evident that the drawings described below pertain to some embodiments of this application. For a person skilled in the art, additional drawings can be derived from these without requiring creative efforts.

FIG. 1 is a schematic diagram of an application scenario for the flight control method described in this application.

FIGS. 2A and 2B are schematic diagrams showing an aircraft flipping over and adhering to a wall after colliding with it.

FIG. 3 is a schematic diagram of a process flow for the flight control method provided in some embodiments of this application.

FIG. 4 is a schematic diagram of a process flow for the flight control method provided in some embodiments of this application.

FIG. 5A is a schematic diagram of a reference pitch attitude deviation provided in some embodiments of this application.

FIG. 5B is a schematic diagram of a control device sending control instructions provided in some embodiments of this application.

FIG. 5C is a schematic diagram of an actual pitch attitude deviation provided in some embodiments of this application.

FIG. 5D is a schematic diagram of an adjustment made based on an error provided in some embodiments of this application.

FIG. 6 is a schematic diagram of a structure of the flight control device provided in some embodiments of this application.

FIG. 7 is a schematic diagram of a structure of the flight control device provided in some embodiments of this application.

### DETAILED DESCRIPTION

To make the objectives, technical solutions, and advantages of the embodiments of this application clearer, the technical solutions in the embodiments will be described clearly and comprehensively below in conjunction with the accompanying drawings. It is evident that the described embodiments represent a portion of the embodiments of this application, not all of them. Based on these embodiments of this application, all other embodiments obtained by a person skilled in the art without creative efforts also fall within the scope of protection of this application.

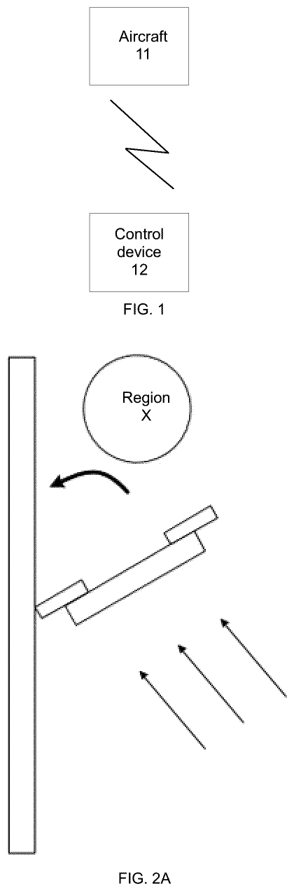

The flight control method provided in the embodiments of this application can be applied to the flight control system shown in FIG. 1. As illustrated in FIG. 1, the flight control system may include an aircraft 11 and a control device 12, which can communicate wirelessly. The aircraft includes a power system composed of multiple motors that provide flight lift. In certain embodiments, the aircraft may include multiple propellers, each driven by a motor. The aircraft also includes a photographing device, a gimbal for mounting and adjusting the pitch attitude of the photographing device, and a body. The gimbal is mounted on the body, and the power system, as mentioned earlier, can also be installed on the body. It is worth noting that this application does not impose limitations on the quantity, type, or form of the aircraft 11 or control device 12.

It will be apparent to a person skilled in the art that the methods described in the embodiments of this application for unmanned aerial vehicles (UAVs) are also applicable to other types of aircrafts. Any type of aircraft may be used without limitation. For instance, the aircraft may be small or large, manned or unmanned. In some embodiments, the aircraft can be a rotary-wing aircraft, such as a multirotor propelled by air with multiple propulsion devices. The aircraft can also be a fixed-wing aircraft or a hybrid of rotary and fixed wings. The embodiments of this application are not limited to these examples, and the aircraft herein can also include other types of aircrafts.

Furthermore, the methods applicable to aircraft in the embodiments of this application are also applicable to movable platforms. A movable platform may refer to any device capable of movement. In some embodiments, the movable platform may have its own power unit, which drives its movement. In other embodiments, the movable platform may require external equipment to facilitate movement. The examples provided herein are for illustrative purposes only, and the specific means of achieving movement for the movable platform are not limited herein. The movable platform may be a manned or unmanned platform. Examples of movable platforms include, but are not limited to, aircraft, vehicles, cleaning devices, ships, tunnel or pipeline inspection equipment, agricultural robots, logistics vehicles, inspection devices, underwater operation equipment, handheld gimbals, action cameras, and so on. In different practical applications, the movable platform can be different types of devices. For instance, in scenarios such as power line inspection, river inspection, or pipeline surveying, the movable platform could be an aircraft. In scenarios like underground pipeline inspection, the movable platform may be an aircraft, a ship, or a mobile robot. Alternatively, the movable platform may be an integrated movable platform capable of navigating air, surface, and underwater environments, or a platform capable of moving both on the ground and in the air, among others.

Exemplarily, the control device 12 can be a terminal device, which may include at least one of a remote controller, smartphone, tablet, laptop, or smart wearable device. The terminal device can have an application (APP) installed for controlling the aircraft 11.

Exemplarily, the control device 12 can be a remote controller. The remote controller can also communicate with a terminal device via wired or wireless connections. Optionally, the remote controller may be equipped with a fixed bracket for securing the terminal device.

Exemplarily, the control device can be augmented reality (AR) equipment, virtual reality (VR) equipment, or similar devices.

The following will provide a detailed description of some embodiments of this application in conjunction with the accompanying drawings. In the absence of any conflict, the embodiments and features described below can be combined with each other.

One abnormal situation that an aircraft might encounter during flight is when it flips over and becomes firmly stuck to an obstacle (such as a wall) after collision. Through analysis, the root cause of this abnormal situation is found to be that, under the impact of the collision with the obstacle, the aircraft's attitude tilts toward the direction of the obstacle. Typically, to adjust the aircraft's attitude to a normal state after a collision, the motor closest to the obstacle is accelerated. As shown in FIG. 2A, the acceleration of the motor near the obstacle rapidly draws air from the region X. This causes the air pressure in region X to decrease. The faster the motor near the obstacle spins, the lower the air pressure in region X becomes. As a result, a low-pressure area is formed on an inner side the obstacle, meaning the air pressure in region X becomes lower than the air pressure beneath the aircraft. The pressure difference between the area above and below the aircraft causes the aircraft to be “pressed” toward the obstacle (as indicated by the arrow in FIG. 2A). This means that the acceleration of the motor closest to the obstacle not only fails to generate a torque to balance the attitude but instead exacerbates the aircraft's attachment to the inner side of the obstacle, forming a positive feedback loop. This ultimately causes the aircraft to become firmly stuck to the obstacle, as shown in FIG. 2B.

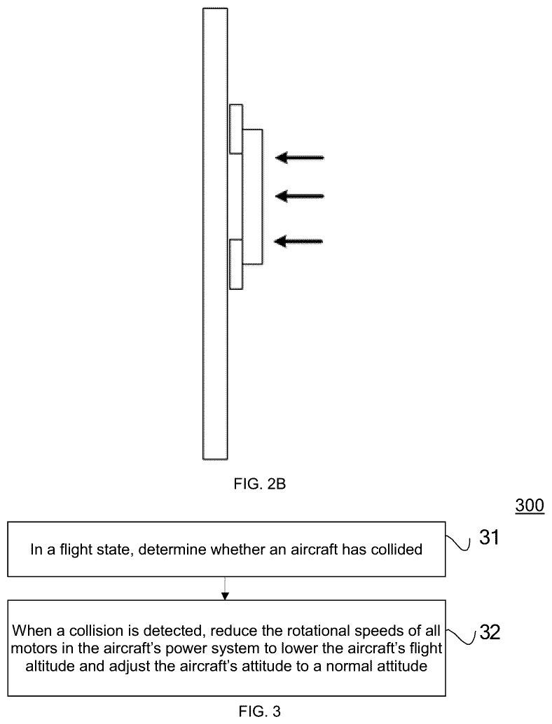

To reduce the occurrence of abnormal situations where the aircraft flips over and becomes firmly stuck to an obstacle after a collision, the embodiments of this application provide a flight control method, as shown in FIG. 3.

FIG. 3 is a schematic diagram of the process flow for the flight control method provided in some embodiments of this application. The method described herein can be applied to the aircraft 11 in FIG. 1, which includes a power system with multiple motors that provide flight lift. Some or all aspects of the process (or any other processes described herein, or variations and/or combinations thereof) may be performed by one or more processors onboard a movable object, a remote control device, any other system or device or a combination thereof. Some or all aspects of the process (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The order in which the operations are described is not intended to be construed as a limitation, and any number of the described operations may be combined in any order and/or in parallel to implement the processes.

As shown in FIG. 3, the method herein may include the following steps:

Step 31: In a flight state, determine whether an aircraft has collided.

In this step, since the abnormal situation of the aircraft flipping over and becoming firmly stuck to an obstacle occurs due to attitude control after the aircraft collides with the obstacle, it is possible to reduce the occurrence of this situation by controlling the aircraft's behavior after the collision. Therefore, the method needs to determine whether a collision has occurred during the flight state. For example, the collision detection can be based on acceleration values and/or the magnitude of disturbances to determine whether the aircraft has collided.

If it is determined that the aircraft has not collided, the process can be ended. If a collision is detected, Step 32 can be further executed.

Step 32: When a collision is detected, reduce the rotational speeds of all motors in the aircraft's power system to lower the aircraft's flight altitude and adjust the aircraft's attitude to a normal attitude.

In this step, when a collision is confirmed, the aircraft exits the attitude control mode and stops controlling the power system to adjust the aircraft's attitude to the normal attitude (i.e., the attitude for hovering). Instead, the speed of all motors in the aircraft's power system is reduced. After lowering the aircraft's flight altitude, the aircraft's attitude is then adjusted to the normal attitude. This process helps to reduce the risk of the aircraft becoming firmly stuck to the obstacle by first reducing its altitude and then stabilizing its attitude.

By reducing the rotational speed of all motors in the aircraft's power system, the aircraft's flight altitude can be lowered. Additionally, since the speed of the motor closest to the obstacle is also reduced, this helps to decrease the pressure difference between the region X and the area below the aircraft. Normally, accelerating the motors near the obstacle would increase the pressure difference and cause a force that “presses” the aircraft toward the obstacle. By lowering the motor speed, this force is reduced, minimizing the risk of the aircraft being pulled toward the obstacle and becoming firmly stuck to it.

Furthermore, by lowering the aircraft's flight altitude, the pressure difference between region X and the area below the aircraft can be reduced, which in turn reduces the force that would normally “press” the aircraft toward the obstacle when adjusting its attitude to the normal attitude. After lowering the aircraft's altitude, adjusting its attitude to the normal attitude can therefore reduce the likelihood of a large pressure difference between region X and the area below the aircraft, which could otherwise cause the aircraft to be firmly stuck to the obstacle. This helps to minimize the occurrence of the abnormal situation where the aircraft flips over after colliding with an obstacle and becomes firmly stuck to it.

The flight control method provided in some embodiments reduces the likelihood of the aircraft flipping over and becoming firmly stuck to an obstacle after collision by first lowering the aircraft's flight altitude and then adjusting its attitude to the normal attitude. This is achieved by detecting a collision during flight and reducing the rotational speed of all motors in the aircraft's power system, which lowers the aircraft's altitude and stabilizes its attitude. This sequence of actions prevents immediate attitude adjustments that could otherwise cause the aircraft to tip over, thus minimizing the occurrence of abnormal situations like the aircraft being firmly stuck to an obstacle after a collision.

Building on the embodiments shown in FIG. 3, it is noted that the propeller guard surrounding the propellers may form a duct, and this duct could obstruct the air interaction between the upper and lower parts of the aircraft. In some embodiments, the method described in FIG. 3 can be applied to aircrafts that include motors driving propellers, with propeller guards surrounding the propellers, forming a duct. In this case, the power system can still include motors driving the propellers, and the aircraft may include the propeller guards surrounding the propellers. The propeller guard can be part of the aircraft's body, meaning the body itself may include the guard, or the guard can be a separate component mounted on the body.

Based on the embodiments shown in FIG. 3, the aircraft may be equipped with a sensor(s) to determine whether a collision has occurred based on the measurements from the sensor(s). In some embodiments, the sensor(s) may include an accelerometer, which can determine whether the aircraft has collided by analyzing the accelerometer's measurement values. Specifically, determining whether the aircraft has collided may include: checking whether the accelerometer's measurement exceeds a first threshold; if the measurement exceeds the first threshold, indicating that a collision has occurred; if the measurement does not exceed the first threshold, indicating that no collision has occurred. For example, the first threshold can be set at 5 g, where g represents gravitational acceleration. This ensures that if the accelerometer's measurement exceeds a certain threshold, it can be inferred that the acceleration is caused by a collision with an obstacle. In some embodiments, the sensor(s) may include an attitude sensor, which can determine whether the aircraft has collided by analyzing the attitude sensor's measurement values. Specifically, determining whether the aircraft has collided may include: checking whether the attitude sensor's measurement exceeds an attitude threshold; if the measurement exceeds the attitude threshold, indicating that a collision has occurred; if the measurement does not exceed the attitude threshold, indicating that no collision has occurred. For example, the attitude threshold can be set at 40, 45, 50, 60, or 70 degrees. This ensures that if the attitude sensor's measurement exceeds a certain threshold, it can be inferred that the acceleration is caused by a collision with an obstacle.

In some embodiments, a disturbance observer can be designed to monitor aircraft attitude disturbances to determine whether a collision has occurred. Specifically, determining whether the aircraft has collided may include: using an observer to monitor the aircraft's attitude disturbances; checking whether the attitude disturbance exceeds a second threshold; if the disturbance exceeds the second threshold, indicating that a collision has occurred; if the disturbance does not exceed the second threshold, indicating that no collision has occurred. This ensures that once the attitude disturbance surpasses a certain threshold, it can be inferred that the disturbance is caused by a collision with an obstacle.

In some embodiments, external disturbances can be calculated using a model to determine whether an aircraft collision has occurred. Specifically, determining whether the aircraft has collided may include: using an inverse model of the aircraft's control system model and the measured angular velocity (velocities) of the motor(s) to calculate the total input of the control system model; subtracting the calculated control amount from a total input to obtain an external disturbance; checking whether the external disturbance exceeds a third threshold; if the disturbance exceeds the third threshold, indicating that a collision has occurred; if the disturbance does not exceed the third threshold, indicating that no collision has occurred. This ensures that once the external disturbance exceeds a certain threshold, it can be inferred that the disturbance is caused by a collision with an obstacle.

Based on some embodiments shown in FIG. 3, the reduction in the rotational speed of all motors can be generally consistent. Herein, “generally consistent” can mean either the reduction in rotational speed is identical for all motors or the difference in reduction remains less than or equal to a specified threshold. By ensuring the reduction in motor speed is generally consistent, the aircraft's attitude can remain essentially unchanged during the process of reducing its altitude.

Based on some embodiments shown in FIG. 3, during the aircraft's altitude reduction process, the tilt angle caused by the collision may remain essentially unchanged. In other words, as the aircraft lowers its altitude, the tilt angle continues to reflect the tilt caused by the collision. This can be achieved by controlling the speed adjustment inputs to maintain a stable tilt angle, which is beneficial for improving flight stability.

In practical applications, the control amounts of the power system can be divided into ascent speed control amounts and attitude control amounts. The ascent speed control amount manages the aircraft's vertical motion, thus controlling its ascent and descent. The attitude control amount governs the aircraft's rotation about its axes (e.g., pitch, roll, and yaw), thereby controlling its attitude. Based on this, and in line with the embodiments shown in FIG. 3, one implementation for reducing the rotational speeds of all motors in the aircraft's power system may include reducing both the ascent speed control amount and the attitude control amount supplied to the power system.

When a proportional-integral-derivative (PID) control algorithm is used to compute the control amounts, clearing the integral term can be employed to reduce the speed control amount. Building on this, and as part of the embodiments shown in FIG. 3, one implementation for reducing the ascent speed control amount and the attitude control amount may involve: clearing an integral term used to calculate the ascent speed control amount to lower the input supplied to the power system; clearing an integral term used to calculate the attitude control amount to reduce the input supplied to the power system. This approach ensures that once the aircraft collides with an obstacle, the flight controller immediately clears the integral terms for vertical and attitude controls. This prevents the control amounts from escalating due to positive feedback. Following the clearing of the integral terms, the aircraft's propellers operate at a low throttle range, maintaining minimal attitude control. This allows the aircraft to stabilize and, once it exits the collision area (Region X), quickly restore normal control functionality.

If the aircraft experiences a minor collision, such as when the attitude is slightly out of control (e.g., less than 45 degrees), the collision detection mechanism may activate upon confirming the aircraft has collided. Under the influence of the algorithm that clears the integral terms for vertical and attitude control, the aircraft maintains a certain level of attitude control even at a low throttle range, allowing it to recover its attitude and return to normal stability. In the case of a severe collision, where the aircraft's attitude flips significantly, such as a 90-degree side flip against an obstacle, the algorithm remains effective. The aircraft may descend under the influence of gravity. If the obstacle is not entirely vertical, such as a tree trunk, once the aircraft gains some distance from the obstacle, it can immediately regain normal attitude and vertical control.

Based on some embodiments shown in FIG. 3, optionally, during flight control adjustments following a collision, the system can also distinguish whether the collision was caused by the user's manual control operation. This differentiation ensures appropriate control responses tailored to the collision's cause.

Based on this, in some embodiments, the method illustrated in FIG. 3 may further include determining whether the collision is caused by the user's manual control operation. Specifically, reducing the rotational speed of all motors in the aircraft's power system may include: if the collision is not caused by manual control, reducing the rotational speed of all motors in the aircraft's power system. For example, this determination can be made by checking whether a user control command was received at the time of the collision. If a user control command is received when the collision occurs, it can be concluded that the collision is caused by manual control. If no user control command is received when the collision occurs, it can be concluded that the collision is not caused by manual control. This approach ensures that the reduction in motor speed only occurs if the collision is not caused by the user's manual control operation. This prevents scenarios where a user intentionally directs the aircraft to collide with an obstacle (e.g., for a task) but instead causes the aircraft to lower its altitude unnecessarily. This method enhances the user experience by avoiding unintended flight behaviors. For instance, if a user manually controls the aircraft to hover near a wall but a collision occurs due to interference or imprecise positioning, the system can reduce the motor speeds to lower the aircraft's altitude safely.

In some embodiments, the method illustrated in FIG. 3 may further include determining whether the collision is caused by the user's manual control operation. Specifically: if the collision is caused by manual control, accelerate all motors based on the user's manual control amount. This ensures that when a collision is determined to be caused by the user's intentional control, the aircraft can correctly execute the user's desired action, such as striking an obstacle as intended. This approach aligns the aircraft's flight control with the user's intent, thereby improving the overall user experience. For example, if a branch obstructs the aircraft's flight, the user may manually command the aircraft to accelerate. In this case, the system would accelerate all motors based on the user's control amount, allowing the aircraft to forcefully push through the branch and continue its flight.

Another abnormal situation that may occur during aircraft flight is that, due to wind disturbances or control errors, the pitch attitude difference between the aircraft's body and the photographing device may drift and cannot be maintained constant. The main scenario where this issue occurs is as follows: in one aircraft control mode, the user can adjust the pitch attitude of the photographing device (for example, the user adjusts the pitch attitude of the aircraft's photographing device via a terminal device as described earlier) to set the pitch attitude deviation between the photographing device and the body as a reference pitch attitude deviation. The user operates the joystick on the terminal device to send flight control commands to the aircraft, which flies based on the received flight control commands. During flight, the pitch attitude of the aircraft's body may change. Ideally, the pitch attitude difference between the photographing device and the body should always remain at the reference pitch attitude deviation. This way, the user can sense and understand the aircraft's body pitch attitude based on the image captured by the photographing device displayed on the terminal device, and then decide how to manipulate the joystick to control the aircraft's flight. However, due to wind disturbances or control errors, the pitch attitude difference between the aircraft's body and the photographing device may drift and fail to remain constant, meaning it cannot be maintained at the reference pitch attitude deviation. This makes it difficult for the user to perceive and understand the aircraft's body pitch attitude based on the image displayed by the photographing device, which in turn affects the user's control of the aircraft's flight.

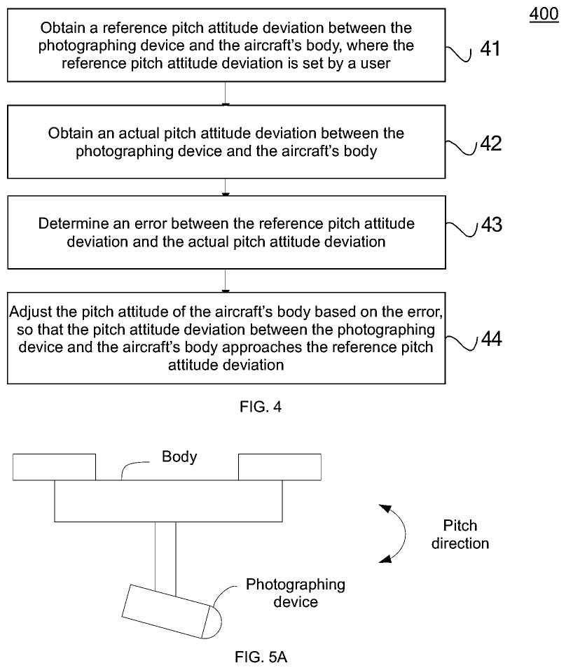

To address the occurrence of this anomaly, some embodiments of this application provide a flight control method as shown in FIG. 4.

FIG. 4 is a flowchart of the flight control method provided by some embodiments of this application. The method provided herein can be applied to the aircraft 11 shown in FIG. 1, where the aircraft includes a photographing device, a gimbal for mounting and adjusting the pitch attitude of the photographing device, and the aircraft's body. The gimbal is mounted on the aircraft's body. As shown in FIG. 4, the method may include:

Step 41: Obtain the reference pitch attitude deviation between the photographing device and the aircraft's body, where the reference pitch attitude deviation is set by the user.

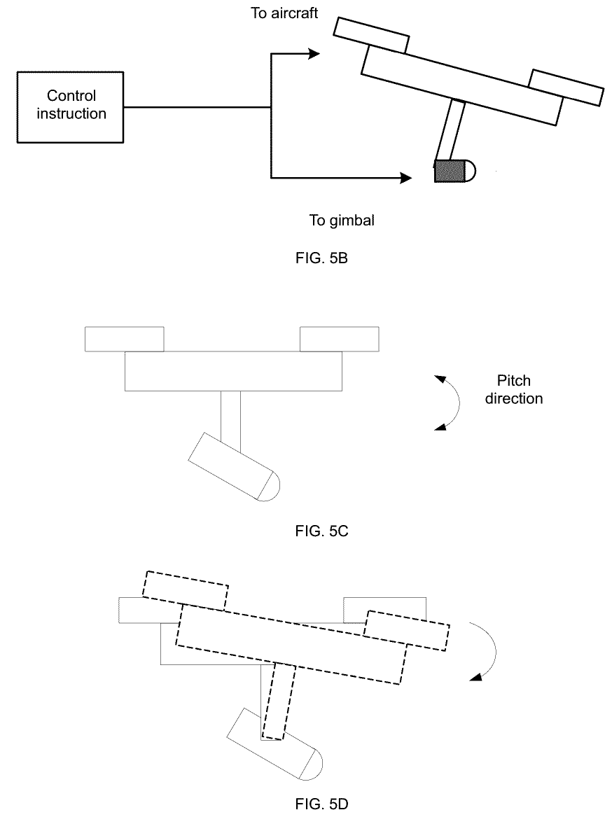

In this step, the reference pitch attitude deviation between the photographing device and the aircraft's body refers to the attitude deviation between the photographing device and the body in the pitch direction of the aircraft's body, as set by the user. The reference pitch attitude deviation between the photographing device and the body, for example, can be as shown in FIG. 5A. The reference pitch attitude deviation between the photographing device and the body can be set by the user by adjusting the attitude of the gimbal. Specifically, adjusting (or setting) the attitude of the gimbal can alter the attitude deviation between the photographing device and the body in the pitch direction of the aircraft's body.

Exemplarily, the reference pitch attitude deviation between the photographing device and the body can be determined based on the user-set gimbal attitude. Of course, in some embodiments, the reference pitch attitude deviation between the photographing device and the body can also be determined in other ways, and the application does not limit this approach.

Step 42: Obtain the actual pitch attitude deviation between the photographing device and the aircraft's body.

As shown in FIG. 5B, during the aircraft control process, the control device sends control commands to adjust the pitch attitude of the aircraft's body and gimbal, so that both the body and the gimbal can move according to the pitch attitude controlled by the control device. Ideally, the pitch attitude change between the photographing device and the aircraft's body in the pitch direction should be identical, allowing the image to reflect the aircraft's pitch attitude change. However, since the speed at which the body and the gimbal adjust their pitch attitudes may be different, after a period of control, errors may arise between the actual pitch attitude deviation and the reference pitch attitude deviation between the photographing device and the body. Therefore, in this step, the actual pitch attitude deviation between the photographing device and the body may be obtained.

The actual pitch attitude deviation refers to the actual pitch attitude difference between the photographing device and the body in the pitch direction of the aircraft's body. The actual pitch attitude deviation between the photographing device and the body, for example, can be as shown in FIG. 5C.

For example, the actual pitch attitude deviation between the photographing device and the aircraft's body may be determined based on the current attitude of the gimbal. Of course, in some embodiments, the actual pitch attitude deviation between the photographing device and the body may also be determined in other ways, and this application does not limit the approach.

Step 43: Determine the error between the reference pitch attitude deviation and the actual pitch attitude deviation.

In this step, after obtaining the reference pitch attitude deviation and the actual pitch attitude deviation, the error between the reference pitch attitude deviation and the actual pitch attitude deviation can be determined. For example, the difference between the reference pitch attitude deviation and the actual pitch attitude deviation can be calculated and defined as the error between the two.

Step 44: Adjust the pitch attitude of the aircraft's body based on the error, so that the pitch attitude deviation between the photographing device and the aircraft's body approaches (moves closer to) the reference pitch attitude deviation.

In this step, to lock the pitch attitude between the photographing device and the aircraft's body in the pitch axis direction of the body, the aircraft may follow the photographing device (which can also be understood as following the gimbal). Therefore, after determining the error between the reference pitch attitude deviation and the actual pitch attitude deviation, the pitch attitude of the aircraft's body can be adjusted based on the error, so that the pitch attitude deviation between the photographing device and the aircraft's body moves closer to the reference pitch attitude deviation. This locks the pitch attitude between the photographing device and the aircraft's body in the pitch axis direction of the body. Based on FIGS. 5A and 5C, the method for adjusting the pitch attitude of the body according to the error can be as shown in FIG. 5D.

It should be noted that the direction indicated by the arrow in FIG. 5D represents the direction of adjusting the pitch attitude of the aircraft's body. When the aircraft's body rotates in the pitch axis direction as shown by the arrow in FIG. 5D, the pitch attitude deviation between the photographing device and the body can be reduced, bringing the pitch attitude deviation closer to the reference pitch attitude deviation. The solid line in FIG. 5D represents the aircraft before adjustment, and the dashed line represents the aircraft after adjustment.

After obtaining the error between the reference pitch attitude deviation and the actual pitch attitude deviation, theoretically, to ensure that the pitch attitude deviation between the photographing device and the aircraft's body should always be the reference pitch attitude deviation, the gimbal can be controlled based on the error to adjust the pitch attitude of the photographing device. This would bring the pitch attitude deviation between the photographing device and the body closer to the reference pitch attitude deviation. However, this approach can cause the photographing device to shake or shift, leading to a shaking or offset display on the terminal device, which could confuse the user and degrade the interactive experience. Therefore, in some embodiments, the pitch attitude of the aircraft's body may be adjusted based on the error, so that the pitch attitude deviation between the photographing device and the aircraft's body moves closer to the reference pitch attitude deviation. This ensures that the display on the terminal device remains stable while still bringing the pitch attitude deviation between the photographing device and the body closer to the reference pitch attitude deviation. The flight control method provided herein involves obtaining the reference pitch attitude deviation between the photographing device and the aircraft's body, obtaining the actual pitch attitude deviation between the photographing device and the aircraft's body, determining the error between the reference pitch attitude deviation and the actual pitch attitude deviation, and adjusting the pitch attitude of the aircraft's body based on the error. This allows the photographing device and the aircraft's body to maintain a stable pitch attitude relationship along the aircraft's body pitch axis, ensuring that the pitch attitude deviation between the photographing device and the body always matches the reference pitch attitude deviation.

Based on some embodiments shown in FIG. 4, the aircraft's body attitude can be adjusted based on the error, specifically by adjusting the body attitude in real-time according to the error. This ensures the real-time nature of the adjustment.

In some embodiments, when the error exceeds a preset error threshold, the body pitch attitude is adjusted based on the error. This reduces the amount of adjustment work required.

In some embodiments shown in FIG. 4, when the aircraft includes a power system, adjusting the body pitch attitude based on the error can specifically involve controlling the power system according to the error to adjust the body pitch attitude. The power system is mounted on the aircraft's body, and in some embodiments, the body may include arms, with the power system mounted on the arms.

Optionally, when performing flight control based on the error, the aircraft's control mode can be distinguished. Based on this, in some embodiments, the method of the embodiments shown in FIG. 4 may further include: determining the control mode of the aircraft. The adjustment of the aircraft's body pitch attitude based on the error can specifically include: when the aircraft's control mode is a first control mode, adjusting the body pitch attitude based on the error. The first control mode can specifically be any type of control mode where the video reflects the aircraft's attitude change in the pitch direction. For example, the first control mode may include First-Person View (FPV) mode or racing mode, where, when the aircraft is in FPV or racing mode, it is necessary to keep the gimbal and the aircraft in a relative stationary position. Thus, in modes that require the video to reflect the aircraft's attitude change in the pitch direction, the body follows the photographing device, allowing the aircraft's control mode to be flexibly implemented, which is beneficial for enhancing the user's experience.

In some embodiments, the method of the embodiment shown in FIG. 4 may further include: when the aircraft's control mode is a second control mode, obtaining an initial pitch attitude of the photographing device, and controlling the gimbal to make the pitch attitude of the photographing device approach the initial pitch attitude. The second control mode can specifically be any type of control mode where the gimbal controls the pitch attitude of the photographing device to remain stable. For example, the second control mode may be a locking mode, where, when the aircraft is in locking mode, the gimbal needs to maintain a fixed attitude relative to the ground. This allows the user to use a control mode where the gimbal stabilizes the photographing device's attitude as needed, which enhances the user's experience.

Optionally, the initial pitch attitude can be set by the user, allowing the user to flexibly adjust the field of view of the photographing device based on shooting needs, which is beneficial for improving the user experience.

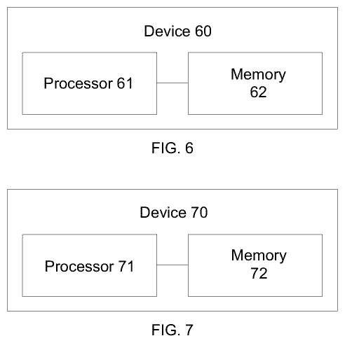

FIG. 6 is a schematic diagram of the structure of a flight control device according to some embodiments of the present application, which is applied to an aircraft. The aircraft includes a power system, which includes multiple motors providing flight lift. As shown in FIG. 6, a device 60 may include: a processor 61 and a memory 62. The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The memory 62 is used to store program code.

The processor 61 calls the program code, and when the program code is executed, the processor 61 performs the following operations:

In the flight state, determining whether the aircraft has collided;

When a collision is detected, reducing the speeds of all motors in the aircraft's power system to lower the aircraft's flight altitude and adjust the aircraft's attitude to a normal attitude.

The flight control device provided herein can be used to implement the technical solutions of the method embodiments shown in FIG. 3, and its underlying principle and technical effects are similar to those of the method embodiments, so they will not be repeated here.

FIG. 7 is a schematic diagram of the structure of a flight control device provided in some embodiments, which is applied to an aircraft. The aircraft includes a photographing device, a gimbal for mounting and adjusting the pitch attitude of the photographing device, and a body. The gimbal is mounted on the body. As shown in FIG. 7, a device 70 may include: a processor 71 and a memory 72.

The memory 72 is used to store program code.

The processor 71 calls the program code, and when the program code is executed, the processor 71 performs the following operations:

Obtaining a reference pitch attitude deviation between the photographing device and the body, where the reference pitch attitude deviation is set by the user;

Obtaining an actual pitch attitude deviation between the photographing device and the body;

Determining an error between the reference pitch attitude deviation and the actual pitch attitude deviation;

Adjusting a pitch attitude of the body according to the error, so that the pitch attitude deviation between the photographing device and the body approaches the reference pitch attitude deviation.

The flight control device provided herein can be used to implement the technical solutions of the methods embodiments shown in FIG. 4. Its implementation principle and technical effects are similar to those of the method embodiments, and will not be repeated here.

Moreover, some embodiments of the application also provide an aircraft, which includes the flight control device shown in FIG. 6 or FIG. 7.

Some embodiments of the application also provide a computer-readable storage medium, which stores a computer program. When executed by a processor, the computer program implements the methods described in the embodiments shown in FIG. 3 or FIG. 4.

A person skilled in the art would understand that: all or part of the steps of the above method embodiments can be accomplished by program instructions and associated hardware. The aforementioned program can be stored in a computer-readable storage medium. When executed, the program performs the steps of the above method embodiments; the aforementioned storage medium includes ROM, RAM, magnetic disks, optical discs, and other media that can store program code.

Finally, it should be noted that the above embodiments are intended to illustrate the technical solutions of this application, and are not intended to limit them. Although the application has been described in detail with reference to the above embodiments, a person skilled in the art would understand that modifications can be made to the technical solutions described in the above embodiments, or some or all of the technical features can be equivalently substituted; such modifications or substitutions do not change the essential nature of the corresponding technical solutions, nor do they depart from the scope of the technical solutions of the embodiments of this application.

What is claimed is:

1. A flight control method, comprising:
in a flight state, in response to a collision between an aircraft and an object, generating a trigger signal for characterizing an abnormality; and
in response to the trigger signal, reducing rotation speeds of all motors in a power system of the aircraft to reduce a flight altitude of the aircraft, and adjusting an attitude of the aircraft to a normal attitude.

2. The method according to claim 1, wherein speed reduction ranges of all the motors are substantially the same.

3. The method according to claim 1, wherein during a process of reducing the flight altitude of the aircraft, a tilt angle of the aircraft caused by the collision is kept substantially unchanged.

4. The method according to claim 1, wherein the power system further includes propellers driven by the motors, and the aircraft includes a propeller guard component surrounding outer sides of the propellers.

5. The method according to claim 1, wherein the reducing of the speeds of all the motors in the power system of the aircraft includes:
in response to the collision not being caused by a manual control operation of a user, reducing the rotation speeds of all the motors in the power system of the aircraft.

6. The method according to claim 1, further comprising:
In response to the collision being caused by a manual control operation of a user, controlling all the motors to accelerate according to the manual control operation of the user.

7. The method according to claim 1, wherein the generating of the trigger signal for characterizing an abnormality in response to the collision between the aircraft and the object includes:
in response to a measurement value of an accelerometer of the aircraft being greater than or equal to a threshold value A, determining that the aircraft collides with the object, and generating the trigger signal.

8. The method according to claim 1, wherein the generating of the trigger signal for characterizing an abnormality in response to the collision between the aircraft and the object includes:
in response to an attitude disturbance of the aircraft being observed by an observer to be greater than or equal to a threshold value B, determining that the aircraft collides with the object, and generating the trigger signal.

9. The method according to claim 1, wherein the generating of the trigger signal for characterizing an abnormality in response to the collision between the aircraft and the object includes:
in response to an external disturbance being greater than or equal to a threshold value C, determining that the aircraft collides with the object, and generating the trigger signal, wherein the external disturbance is determined based on an input amount and a control amount of a control system model of the aircraft.

10. The method according to claim 1, wherein the reducing of the speeds of all motors in the power system of the aircraft includes:
reducing an ascent speed control amount and an attitude control amount provided to the power system.

11. A flight control device, comprising:
at least one storage medium storing at least one set of instructions; and
at least one processor in communication with the at least one storage medium, wherein during operation, the at least one processor executes the at least one set of instructions to cause the device to at least:
in a flight state, in response to a collision between an aircraft and an object, generate a trigger signal for characterizing an abnormality, and
in response to the trigger signal, reduce rotation speeds of all motors in a power system of the aircraft to reduce a flight altitude of the aircraft, and adjust an attitude of the aircraft to a normal attitude.

12. The device according to claim 11, wherein speed reduction ranges of all the motors are substantially the same.

13. The device according to claim 11, wherein during a process of reducing the flight altitude of the aircraft, a tilt angle of the aircraft caused by the collision is kept substantially unchanged.

14. The device according to claim 11, wherein the power system further includes propellers driven by the motors, and the aircraft includes a propeller guard component surrounding outer sides of the propellers.

15. The device according to claim 11, wherein to reduce the speeds of all the motors in the power system of the aircraft, the at least one processor executes the at least one set of instructions to cause the device to at least:
in response to the collision not being caused by a manual control operation of a user, reduce the rotation speeds of all the motors in the power system of the aircraft.

16. The device according to claim 11, wherein the at least one processor executes the at least one set of instructions to further cause the device to at least:
In response to the collision being caused by a manual control operation of a user, control all the motors to accelerate according to the manual control operation of the user.

17. The device according to claim 11, wherein to generate the trigger signal for characterizing an abnormality in response to the collision between the aircraft and the object, the at least one processor executes the at least one set of instructions to cause the device to at least:
in response to a measurement value of an accelerometer of the aircraft being greater than or equal to a threshold value A, determine that the aircraft collides with the object, and generating the trigger signal.

18. The device according to claim 11, wherein to generate the trigger signal for characterizing an abnormality in response to the collision between the aircraft and the object, the at least one processor executes the at least one set of instructions to cause the device to perform at least one of:
in response to an attitude disturbance of the aircraft being observed by an observer to be greater than or equal to a threshold value B, determining that the aircraft collides with the object, and generating the trigger signal; or
in response to an external disturbance being greater than or equal to a threshold value C, determining that the aircraft collides with the object, and generating the trigger signal, wherein the external disturbance is determined based on an input amount and a control amount of a control system model of the aircraft.

19. The device according to claim 11, wherein to reduce the speeds of all motors in the power system of the aircraft, the at least one processor executes the at least one set of instructions to cause the device to at least:
reduce an ascent speed control amount and an attitude control amount provided to the power system.

20. An aircraft, comprising:
at least one storage medium storing at least one set of instructions; and
at least one processor in communication with the at least one storage medium, wherein during operation, the at least one processor executes the at least one set of instructions to cause the device to at least:
in a flight state, in response to a collision between an aircraft and an object, generate a trigger signal for characterizing an abnormality, and
in response to the trigger signal, reduce rotation speeds of all motors in a power system of the aircraft to reduce a flight altitude of the aircraft, and adjust an attitude of the aircraft to a normal attitude.
